(19) United States
(12) Patent Application Publication
(10) Pub. No.: US 2008/0152935 A1
(43) Pub. Date: Jun. 26, 2008

(54) BARRIER COATINGS

(75) Inventors: John R. Zern, Cheswick, PA (US); Ken W. Niederst, Allison Park, PA (US)

Correspondence Address: PPG INDUSTRIES INC;INTELLECTUAL PROPERTY DEPT, ONE PPG PLACE, PITTSBURGH, PA, 15272, US

(73) Assignee: PPG Industries Ohio, Inc., Cleveland, OH (US)

(21) Appl. No.: 12/045,062

(22) Filed: Mar. 10, 2008

Related U.S. Application Data
(63) Continuation of application No. 10/960,330, filed on Oct. 7, 2004, now abandoned.

(51) Int. Cl. C08G 8/02; B32B 27/32

(52) U.S. Cl. 428/523; 528/126

(57) ABSTRACT

A barrier coating comprising the reaction product of a polymeric material and an acid is disclosed. Methods for improving the barrier of a substrate, and substrates treated according to this method are also disclosed.

### CROSS-REFERENCE TO RELATED APPLICATIONS

This application is a continuation of U.S. patent application Ser. No. 10/960,330 filed Oct. 7, 2004, entitled “Barrier Coatings”.

### FIELD OF THE INVENTION

The present invention is directed to barrier coatings comprising the reaction product of a polymeric material and an acid. Methods for improving the barrier of a substrate are also within the present invention.

### BACKGROUND INFORMATION

Plastics have found increasing use as replacements for glass and metal containers in packaging. Advantages of plastic packaging over glass packaging include lighter weight, decreased breakage and potentially lower costs. An advantage of plastic packaging over metal packaging is that plastic can more easily be designed as re-closable. Shortcomings in the gas barrier properties of common plastic packaging materials (e.g., polyesters, polyolefins and polycarbonates) can be a problem when such materials are used to package oxygen-sensitive items and/or carbonated beverages. For example, some oxygen-sensitive products may become discolored and/or spoiled upon even minute exposures to oxygen, and carbonated beverages can lose their carbonation or become “flat” if carbon dioxide is removed.

Specifically, gases such as oxygen and carbon dioxide can readily permeate through most of the plastic materials commonly used by the packaging industry. The oxygen permeability constant (“P(O₂)”) quantifies the amount of oxygen that can pass through a film or coating under a specific set of circumstances and is generally expressed in units of cm³-mil/100 inches²/atmosphere/day. This is a standard unit of permeation measured as cubic centimeters of oxygen permeating through 1 mil (25.4 micron) thickness of a sample, 100 square inches (645 square centimeters) in an area, over a 24-hour period, under a partial pressure differential of one atmosphere at specific temperature and relative humidity (R.H.) conditions. As used herein, P(O₂) values are reported at 23° C.+/−5° C. and an R.H. of 50 percent unless otherwise stated.

One of the common packing materials used today by the food and beverage industry is poly(ethylene terephthalate) (“PET”). Notwithstanding its widespread use, PET has a relatively high P(O₂) value (i.e., about 6.0). Other packaging materials such as polyesters, polyolefins, polycarbonates and the like are similarly gas permeable. The food and beverage packaging industry has sought ways to improve the P(O₂) value of such packaging materials.

### SUMMARY OF THE INVENTION

The present invention is directed to a barrier coating comprising the reaction product of a polymeric material and an acid, wherein the coating does not comprise diglycidyl ether or residues thereof when the acid is an organic diacid, the coating does not comprise a silane material or residues thereof, and the coating does not comprise polyamine when the acid is ethylenically unsaturated. The present invention is further directed to methods for improving the barrier of a substrate using barrier coatings comprising the reaction product of a polymeric material and an acid, as described herein.

### DETAILED DESCRIPTION OF THE INVENTION

The present invention is directed to a barrier coating comprising the reaction product of a polymeric material and an acid, wherein the coating does not comprise diglycidyl ether or residues thereof when the acid is an organic diacid, the coating does not comprise a silane material or residues thereof, and the coating does not comprise a polyamine when the acid is ethylenically unsaturated. “Barrier coating” refers to a coating having a low permeability to gases such as oxygen and/or carbon dioxide; that is, the coating exhibits resistance to the passage of oxygen, carbon dioxide and/or other gases through the material. Any resistance to permeation of any gas is sufficient to qualify the coating as a “barrier coating” according to the present invention.

Any polymeric material, including combinations of polymeric material, can be used according to the present invention within the parameters set forth above; that is, the coating does not comprise diglycidyl ether or residues thereof when the acid is an organic diacid. “Diglycidyl ether or residues thereof” will be understood as referring to compounds either having or made from a diglycidyl ether. The coating does not have and is not made from a silane material, such as SiH₄, wherein one or more of the hydrogens may be replaced with a hydrocarbon. Finally, the coating does not comprise a polyamine when the acid is ethylenically unsaturated.

Particularly suitable polymeric materials for use in the present invention are those that will impart a barrier effect when deposited onto a substrate and cured in a coating. “Polymeric material” refers generally to hydrocarbons having one or more functional groups that will react with an acid and more than one repeat group. In certain nonlimiting embodiments, a polymeric material that can be cured by actinic radiation is specifically excluded. Particularly suitable are polymeric materials having aromaticity. Also particularly suitable are epoxy-containing materials and/or amine-containing materials. “Epoxy-containing” and like terms will be understood by those skilled in the art as referring to any material having or made from one or more epoxy groups. A wide variety of epoxy-containing materials, such as polyepoxides, may be utilized in the present invention. The epoxides may be saturated or unsaturated, aliphatic, cycloaliphatic, aromatic, or heterocyclic and may be substituted, if desired, with noninterferring substituents such as hydroxyl groups or the like.

Examples of useful polyepoxides are polyglycidyl ethers of aromatic polyols, e.g., polyphenols. Such polyepoxides can be produced, for example, by etherification of an aromatic polyol with epichlorohydrin or dichlorohydrin in the presence of an alkali. The aromatic polyol may be, e.g., bis(4-hydroxyphenyl)-2,2-propane (generally known as bisphenol A), bis(4-hydroxyphenyl)-1,1-ethane, bis(4-hydroxyphenyl)-1,1-isobutane, bis(4-hydroxytertiarybutylphenyl)-2,2-propane, bis(2-hydroxynaphthyl)methane, 4,4′-dihydroxybenzophenone, 1,5-dihydroxynaphthalene and the like.

Other suitable polyepoxides include but are not limited to polyglycidyl ethers of polyhydric aliphatic alcohols such as 1,2-ethanediol, 1,2-propanediol, 1,3-propanediol, 1,4-butanediol, 1,5-pentanediol, diethylene glycol, triethylene glycol, polyethylene glycol, polypropylene glycol and the like. Similarly, the polyhydric aliphatic alcohols may be a hydrogenated polyphenol such as 2,2-bis(4-hydroxycyclohexyl)propane and the like. Blends of various polyepoxides, e.g., blends of polyepoxides of aromatic polyols and aliphatic polyols, or any other epoxy-containing materials, may also be used.

In certain nonlimiting embodiments, the polyepoxides have molecular weights above about 86, such as from about 200 to about 700, or from about 200 to about 400, and have epoxy equivalent weights of above about 43, such as about 100 to about 350, or from about 100 to about 200.

Epoxy-containing products are widely commercially available and include, for example, tetraglycidal-meta-xylene-diamine, commercially available as TETRAD-X from Mitsubishi Gas Chemical Co., epoxy-containing materials are also commercially available from Resolution and Dow.

“Amine-containing compound” and like terms will be understood as referring to compounds having an amine group and/or amine functionality, including but not limited to polyamines. In certain nonlimiting embodiments, the amine functionality can be introduced, for example, directly on an epoxy-containing compound. For example, TETRAD-X can be used. In certain nonlimiting embodiments, a separate amine-containing compound can be used in conjunction with an epoxy-containing compound. Polyamines used in the present invention can have one or more primary amino nitrogen groups per molecule and may also have other secondary or tertiary amino nitrogen groups. Such polyamines can be aliphatic polyamines of the formula (R′)₂N—(—RNH—R)ₙN(R′)₂, wherein R is a C₂ to C₆ alkylene group, such as a C₂ to C₄ alkylene group such as ethylene, isopropylene and the like, R′ is a hydrogen, a lower alkyl group such as methyl, ethyl and the like, or a hydroxyalkyl group wherein the alkyl group contains from about 1 to 4 carbon atoms, and n is an integer from 0 to about 10, such as from about 1 to about 5. Suitable examples of such polyamines include ethylenediamine, diethylenetriamine, triethylenetetramine, tetraethylenepentamine, N-hydroxyethyl ethylenediamine, N-hydroxyethyl diethylenetriamine, N,N-dihydroxyethyl diethylenetriamine, meta-xylene diamine, and the like. The polyamine may also be an aromatic polyamine such as para-diaminobenzene, 4,4′-diaminophenylaniline, and the like. The polyamine may also be a ketone blocked polyamine, sometimes referred to as a ketimine, e.g., a polyamine, such as tetraethylenepentamine, may be reacted with a ketone, such as methyl isobutyl ketone and the like, to give a polyamine having the primary amine groups blocked and three remaining reactive secondary amine groups. Diprimary amine group-containing polyamines are suitable in the reaction to form the ungelled amine-functional polymeric resin, as are triethylenetetramine, tetraethylenepentamine, and tetraethylenepentamine.

Ammonia may also be a precursor to a suitable polyamine, e.g., two moles of ammonia may be reacted with one mole of a suitable diepoxide, such as a diglycidyl ether of bisphenol A, to produce a diprimary amine-functional material useful in the present invention. The polyamine may also be polyethyleneimine and the like. Still further, the polyamine may also be a polyoxyalkylene-polyamine such as the material described in U.S. Pat. No. 4,423,166 for preparation of an ungelled material used in electrodeposition.

A particularly suitable polyamine is commercially available from Mitsubishi Gas Chemical Co. as GASKAMINE, which is a low molecular weight polyamine. It will be appreciated that the amine-containing compound, if used in the reaction product of the present invention, actually forms part of the reaction product, and is not used as a catalyst, which would not form part of the reaction product.

If both epoxy-containing and amine-containing compounds are used, they can be used in an equivalent ratio of amine to epoxy of 5.0:1 to 0.20:1.

Any organic or inorganic acid can be used to form the reaction product of the present invention. In certain nonlimiting embodiments, the acid is a monoacid; examples include but are not limited to lactic acid, nitric acid and acetic acid. In other nonlimiting embodiments, a multi-acid is used. “Multi-acid” refers to acids having two or more acid functional groups. Examples include but are not limited to citric acid, phosphoric acid, tartaric acid, itaconic acid, succinic acid, EDTA (ethylenediamine tetracetic acid), ascorbic acid, butanetetracarboxylic acid, tetrahydrofuran tetracarboxylic acid, cyclopentane tetracarboxylic acid, benzene tetracarboxylic acid, and citraconic, mesaconic, maleic, fumaric, acrylic, methacrylic, sorbic, vinyl phosphonic, vinyl sulfonic, and cinnamic acids. In certain nonlimiting embodiments, it will be appreciated that the acid and the polymeric material form a reaction product, and not a graft copolymer with a polymeric backbone and acid grafted thereto.

The reaction product of the present invention can be made in water or solvent or combinations thereof. For example, a reaction product according to certain nonlimiting embodiments of the present invention can be made by mixing an acid with an epoxy-containing compound and then adding the mixture to water. An exothermic reaction will take place; when the reaction is substantially complete, the product can be applied to the substrate. Alternatively, the acid can be placed in water, and then an epoxy-containing compound can be added. The barrier results are typically better when the acid and epoxy together are added to the water.

Another reaction product within the scope of the present invention can be prepared by mixing an amine-containing compound having high solids content with acid, and adding an epoxy-containing compound. By “high solids” in reference to the polyamine is meant 50 percent solids or higher, such as 70 percent solids or higher, or substantially 100 percent solids.

The reaction product can be applied as a coating to a substrate as further described below. The coatings of the present invention can further comprise additives known to those skilled in the art, including inorganic filler particles, pigments, silicones, surfactants and catalysts. Inorganic fillers and pigments, in addition to imparting color and/or tint to the barrier coating, can also even further enhance gas barrier properties of the resultant coating. If employed, the weight ratio of pigment to binder can be not more than 1:1, such as not more than 0.3:1, or not more than 0.1:1. The binder weight used in these ratios is the total solids weight of the polymeric material in the gas barrier coating composition. Particularly suitable are inorganic fillers including platelet-shaped fillers such as mica, vermiculite, clay, talc, micaceous iron oxide, silica, flaked metals, flaked graphite, flaked glass and the like.

Silicones may be included in the barrier coating compositions of the present invention to assist in wetting the substrate over which the barrier material is applied. Generally, silicones useful for this purpose include various organosiloxanes such as polydimethylsiloxane, polymethylphenylsiloxane and the like. Specific examples of such include SF-1023 silicone (a polymethylphenylsiloxane available from General Electric Co.), AF-70 silicone (a polydimethylsiloxane available from General Electric Co.), and DF-100 S silicone (a polydimethylsiloxane available from BASF Corp.). If employed, such silicones are typically added to the gas barrier coating composition in amounts ranging from 0.01 to 1.0 percent by weight based on total resin solids in the gas barrier coating composition.

Surfactants may be included in the present barrier coating compositions. Examples of surfactants that can be used for this purpose include any suitable nonionic or anionic surfactant known in the art. If employed, such surfactants are typically present in an amount ranging from 0.01 to 2.0 percent by weight based on the total weight of the barrier coating composition.

Catalysts can also be included in the barrier coating composition of the invention to aid in the reaction between the acid any of the components comprising the polymeric material.

The coating can comprise 10 to 90, such as 20 to 80 or 45 to 70 weight percent acid, and 90 to 10, such as 80 to 20 or 55 to 30 weight percent polymeric material, with weight percent based on total solids weight of the coating. If other additives are included, they can comprise up to 15 weight percent, with weight percent based on total solids weight of the coating. In certain embodiments, the acid comprises 50 weight percent or greater, such as 60 weight percent or greater or 70 weight percent or greater, with weight percent based on total solids weight of the coating.

The coating composition of the present invention can be immediately applied to the substrate upon formation, or held for a period of time of eight hours or even longer. A feature of the present invention is that the pot-life of the present coatings is significantly increased, as compared to the pot life of similar compositions made without an acid.

The present invention is further directed to a method for improving the barrier of a substrate comprising coating at least a portion of the substrate with any of the coatings described above. The composition can be applied by any conventional means such as spraying, rolling, dipping, brushing, flow coating and the like. After application to the substrate, the coating compositions may be cured at ambient or elevated temperatures.

The barrier coatings of the present invention can have any suitable or desirable dry film thickness. Although thicker coatings typically provide increased gas barrier properties, thinner coatings are often preferred for economic reasons. Generally, the coatings of the present invention will have a dry film thickness of 1 mil or less, such as 0.5 mil or less or 0.3 mil or less.

The barrier coatings of the present invention can have a P(O₂) of 0.5 or less, such as 0.1 or less, 0.01 or less, or even 0.001 or less cm³-mil/100 inches²/atmosphere/day.

The coating compositions of the present invention can be applied over the substrate as a single layer or as multiple layers with multiple heating stages to remove the solvent from each subsequent layer if desired.

In certain nonlimiting embodiments of the present invention, the barrier coating described herein is the only barrier coating on the substrate; that is, the present barrier coating is not used in conjunction with any other barrier coatings.

Any suitable substrate can be coated according to the present methods. Typically, the substrates will be those that have gas permeability, such as polymers, including but not limited to, polyesters, polyolefins, polyamides, cellulosics, polystyrenes, polyacrylics and polycarbonates. The polyester particularly suitable for treatment according to the present methods is PET, poly(ethylenenaphthalate) (“PEN”) and/or combinations thereof.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa. Also, as used herein, the term “polymer” is meant to refer to prepolymers, oligomers and both homopolymers and copolymers; the prefix “poly” refers to two or more.

### EXAMPLES

The following examples are intended to illustrate the invention, and should not be construed as limiting the invention in any way.

### Example 1

Gas barrier coating compositions were prepared by mixing the epoxy and coreactants, if any, with an organic acid as shown in Table 1. Minor additives, if used, were added (for example to control flow) at this point. Deionized water was then added slowly and incrementally. An exotherm occurred. For Sample 2, 10 g of 90/10 mixture of DOWANOL PM acetone was used as a cosolvent and for Sample 5, 44.6 g of 100 percent DOWANOL PM was used to get 40 percent solids.

TABLE 1

| | Sample 1 | Sample 2 | Sample 3 | Sample 4 | Sample 5 |
|---|---|---|---|---|---|
| Epoxy¹ | 6.40 g | 32.50 g | 5.03 g | 2.00 g | 10.0 g |
| Amine² | 15.12 g | — | 5.03 g | 1.50 g | 19.7 g |
| Citric Acid | 36.62 g | 30.00 g | — | 6.50 g | — |
| Tartaric Acid | — | — | 20.18 g | — | — |
| Deionized | 41.86 g | 37.50 g | 19.76 g | 4.90 g | 1.2 g |
| water | | | | | |

¹Mitsubishi Gas Chemical Company's TETRAD-X.
²Mitsubishi Gas Chemical Company's GASKAMINE 328.

The samples were then applied to a 2 mil (50.8 microns) PET film using a 09 wire wound drawdown rod.

These were baked 8 minutes at 82° C. Final coating film thickness was approximately 0.25 mil (6.35 microns). Each coated PET film was tested for oxygen permeability at 23° C. and 50 percent relative humidity using an OX-TRAN 2/20. Oxygen permeability constants (P(O₂)) for the gas barrier coatings were calculated using the equation 1/Rₐ=1/R_{b}+DFT/P(O₂) where Ra represents the coated film transmission rate in cubic centimeters/100 inches²/atmosphere/day; R_{b} represents the film transmission rate for PET; DFT represents the dry film thickness of the coating in mils and P(O₂) represents the oxygen permeability constant of the coating in cubic centimeters-mil/100 inches²/atmosphere/day. Results are presented in Table 2.

TABLE 2

| Sample | |
|---|---|
| No. | P(O₂) Values |
| 1 | 0.0003 |
| 2 | 0.0028 |
| 3 | 0.0024 |
| 4 | 0.0014 |
| 5 | 0.06 (30° C., 50% R.H.) |

As can be seen in Table 2, the coatings prepared according to the present invention (Samples 1 to 4) gave P(O₂) values at least an order of magnitude lower than those obtained when a coating without an acid (Sample 5) was used.

Whereas particular embodiments of this invention have been described above for purposes of illustration, it will be evident to those skilled in the art that numerous variations of the details of the present invention may be made without departing from the invention as defined in the appended claims.

What is claimed is:

1. A barrier coating comprising the reaction product of a polymeric material and an acid, wherein the coating does not comprise diglycidyl ether or residues thereof when the acid is an organic diacid, wherein the coating does not comprise a silane material or residues thereof, and wherein the coating does not comprise a polyamine when the acid is ethylenically unsaturated.

2. The coating composition of claim 1, wherein the polymeric material is aromatic.

3. The coating composition of claim 1, wherein the polymeric material comprises an epoxy-containing material.

4. The coating composition of claim 3, wherein the polymeric material further comprises an amine-containing material.

5. The coating composition of claim 4, wherein the polymeric material comprises tetraglycidal-meta-xylene-diamine.

6. The coating composition of claim 1, wherein the acid is a monoacid.

7. The coating composition of claim 1, wherein the acid is a multi-acid.

8. The coating composition of claim 7, wherein the acid is citric acid.

9. A method for improving the barrier of a substrate comprising coating at least a portion of the substrate with the coating of claim 1.

10. The method of claim 9, wherein the substrate comprises PET.

11. A substrate treated according to the method of claim 9.

12. The substrate of claim 11, wherein the substrate comprises PET.

13. The substrate claim 11, wherein the oxygen permeation of the barrier coating is less than 0.01 cm³-mil/100 inches²/atmosphere/day.

14. The substrate claim 11, wherein the oxygen permeation of the barrier coating is less than 0.001 cm³-mil/100 inches²/atmosphere/day.
